(19) United States
(12) Patent Application Publication
(10) Pub. No.: US 2011/0187517 A1
(43) Pub. Date: Aug. 4, 2011

(54) Safety Warning Light

(76) Inventor: Andrew J. Roths, Kenmore, WA (US)

(21) Appl. No.: 13/016,503

(22) Filed: Jan. 28, 2011

Related U.S. Application Data
(60) Provisional application No. 61/299,469, filed on Jan. 29, 2010.

(51) Int. Cl. B62J 6/00; G08B 19/00; G08B 21/00; H05B 37/02

(52) U.S. Cl. 340/432; 340/522; 340/600; 340/669; 315/291; 315/294

(57) ABSTRACT

A method of providing a safety warning light for a traveler over a period of months of intermittent travel, that makes use of a battery operated lighting apparatus that provides light when motion and darkness are detected and that when still or in daylight uses, on average, less than 4 milliamps of power. The lighting apparatus is used over the period of months without activating any switch prior to use or deactivating any switch after use.

### RELATED APPLICATIONS

This application claims priority from provisional application No. 61/299,469, filed Jan. 29, 2010, which is hereby incorporated by reference as if fully set forth herein.

### BACKGROUND

A safety warning light designed to warn car drivers of the presence of a bicycle rider or pedestrian is an important element in avoiding accidents. Unfortunately, those using a safety light must remember to turn on the safety light in order for it to play its protective role. This may be an especially challenging task for children. Also, those riding a bicycle or walking as it gradually becomes dark or as they travel into a shadow or tunnel may not remember to activate the safety light, thereby exposing themselves to danger. Moreover, if one fails to deactivate the safety light after use it will quickly drain the batteries, then confronting the user with another required action to obtain continued beneficial use.

Although U.S. Pat. No. 7,057,153 discloses a system that is activated upon the condition of detected motion and darkness. There appears, however, to be no disclosure of a device that would use so little electricity in the “no motion detected” state that it would not be possible to leave the device in a “ready” state in which it could be activated by motion and darkness, without frequently changing the batteries. Rather, it appears likely that, practically, this device would need to be equipped with a manual switch to selectively place it in a “ready” state, in which it would be motion and darkness activated and a “hard off” state, in which the batteries would be preserved. As such this would not serve the purpose of relieving a user of needing to flip a switch, or frequently and wastefully replacing batteries.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention may take the form of a method of providing a safety warning light for a traveler over a period of months of intermittent travel, that makes use of a battery operated lighting apparatus that provides light when motion and darkness are detected and that when still or in daylight uses, on average, less than 4 milliamps of power. The lighting apparatus is used over the period of months without activating any switch prior to use or deactivating any switch after use.

In a second separate aspect, the present invention may take the form of a battery operated lighting apparatus that provides light when motion and darkness are detected and that when still or in ambient light uses less than 4 milliamps of current.

In a third separate aspect, the present invention may take the form of a battery operated lighting apparatus that includes a battery, producing a battery voltage, and a light producing assembly that is, at times, driven by electrical pulses having a duty factor, and wherein the duty factor is varied in inverse proportion to battery voltage, so that as the battery voltage decreases over battery life, the duty factor is increased so as to maintain a substantially constant illumination level.

In a fourth separate aspect, the present invention may take the form of a battery operated lighting apparatus that is activated, at least in part, in response to darkness, and wherein the lighting apparatus includes at least two light sensors placed to detect light levels in differing directions from the lighting apparatus, and wherein readings from at least two of the light sensors are used in a determination of a darkness condition.

In a fifth separate aspect, the present invention may take the form of a battery operated lighting apparatus that is activated by presence of darkness and motion and including a hard-off user input that when activated places the lighting apparatus in a hard off state in which the apparatus will remain deactivated without regard to the presence of motion and darkness.

In a sixth separate aspect, the present invention may take the form of a battery operated lighting apparatus that is activated by presence of darkness and motion and in which motion must occur twice, at least one time-duration apart, for the device to be activated, in order to prevent accidental activations due to temporary motion.

In a seventh separate aspect, the present invention may take the form of a battery operated lighting device that detects a low battery condition and emits a signal to alert a user of the condition.

In an eighth separate aspect, the present invention may take the form of a battery operated lighting apparatus that is activated by the presence of motion and darkness, and wherein when motion at a rate greater than once per every fifteen seconds, the rate of checking for darkness is maintained a rate of less than once per fifteen seconds, in order to preserve battery power.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced drawings. It is intended that the embodiments and figures disclosed herein are to be considered illustrative rather than restrictive.

FIG. 1 is a flow diagram of a method that forms a portion of a preferred embodiment of the present invention.

FIG. 2 is a perspective view of a light unit according to the present invention.

FIG. 3 is a schematic diagram of an electrical network that forms a portion of a preferred embodiment of the present invention.

FIG. 4 is a timing diagram, illustrating the pulse width modulation scheme used by a preferred embodiment of the present invention.

### DETAILED DESCRIPTION OF THE PREFERRED EMBODIMENTS

### 1.0 High Level Description

A preferred embodiment of the safety warning light that is the subject of this application has the following advantages:

1. Elimination of Requirement for User On/Off Switching—When either motion or darkness is not present, it enters a deep sleep mode that consumes less than 20 microamps of electricity, thereby permitting very long battery life. This feature excuses the user from the need to remember to turn the light on and off.

2. Unvarying Light Intensity—It compensates for low battery voltage by increasing the duty factor at which a set of LEDs are driven during LED “on” times, thereby maintaining a uniform brightness over time.

3. Photosensor Positioning—It detects light at three locations, or in an alternative preferred embodiment, two locations, thereby avoiding deactivation due to directional illumination, such as from a street light.

4. Forced off state permits transportation of a bicycle with the light attached, without draining the device batteries.

### 2.0 Operation Referenced to Flow Chart

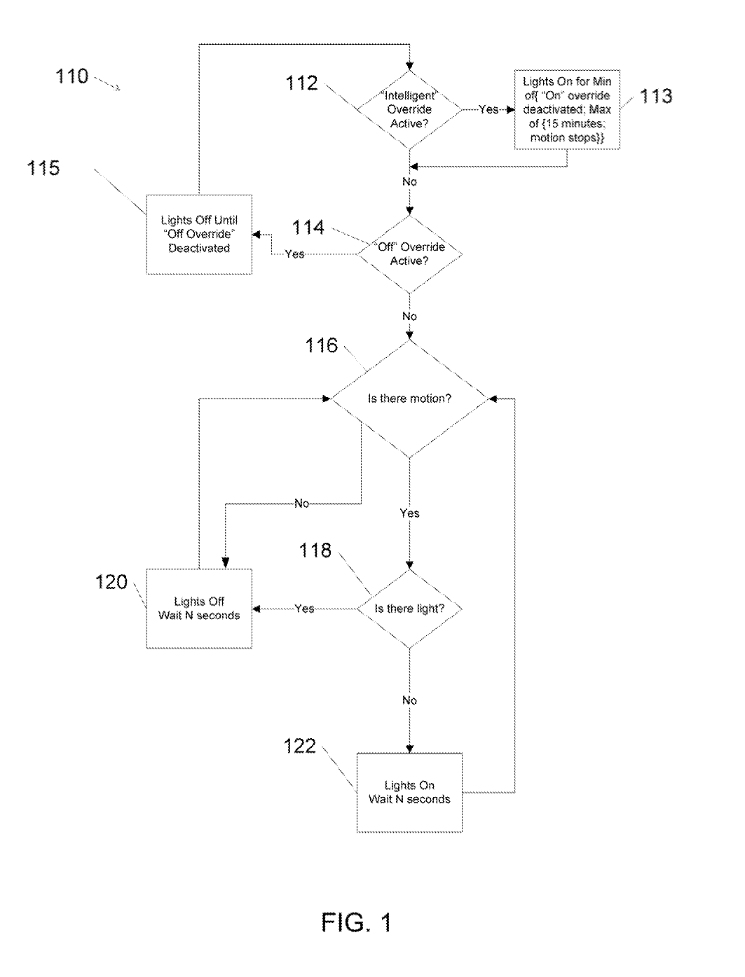

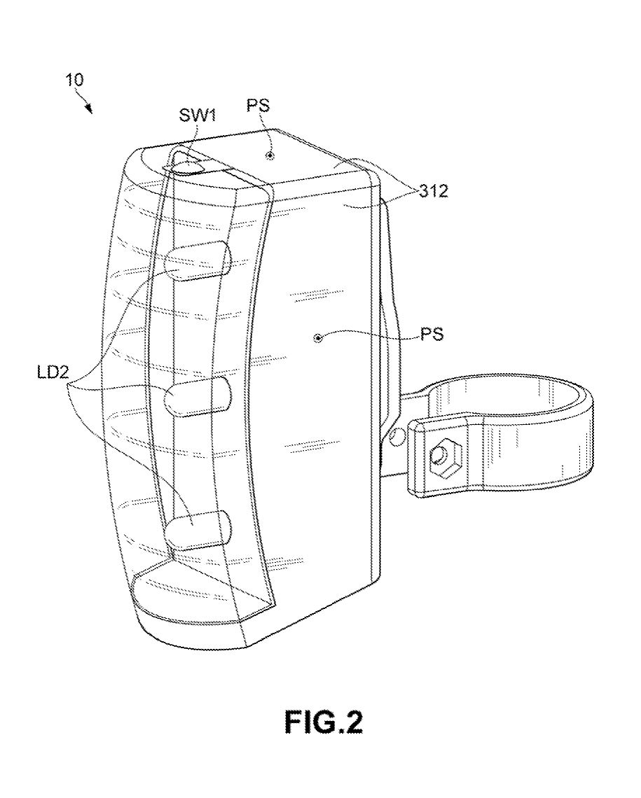

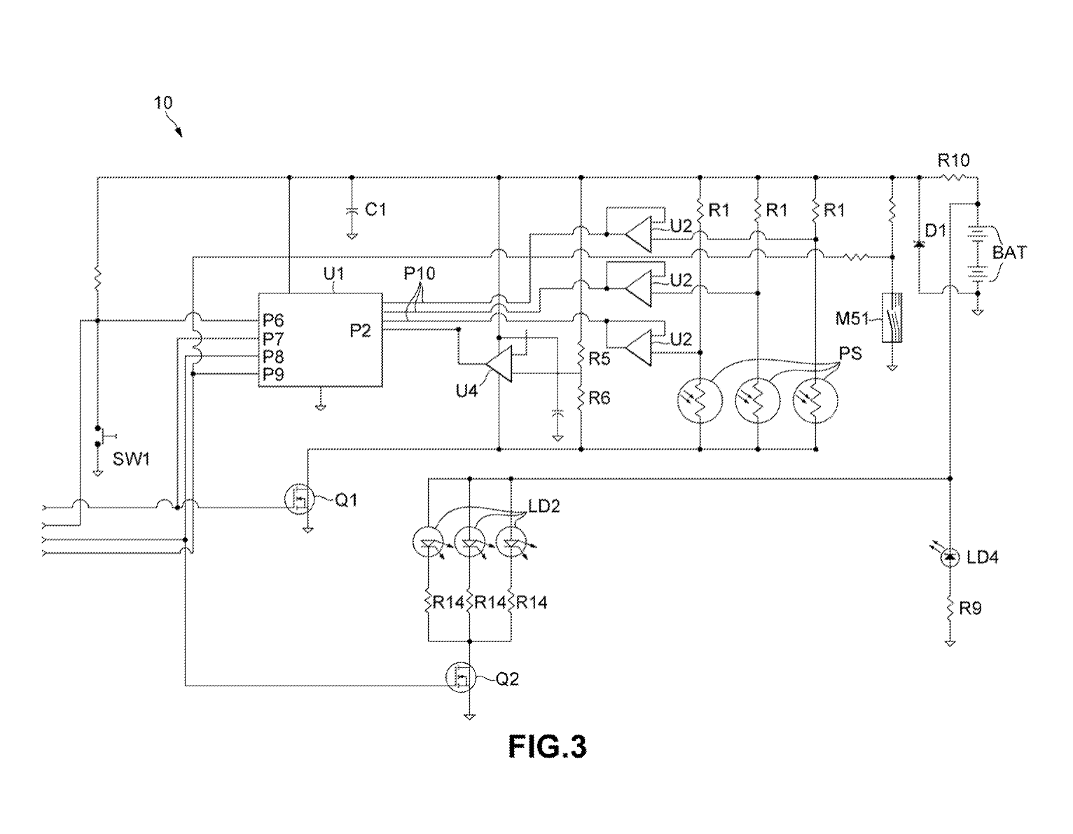

Referring to FIG. 1, in one preferred embodiment, logic process 110 of the safety light 10 (FIG. 2), starts with the decision boxes (112, 114) testing for the “intelligent” override and the “off” override. These two conditions result from a user switching push-button switch SW1 (FIGS. 2 and 3) to place light 10 into one of these two states, an “intelligent override activated” state (process block 113) in which the light remains on for fifteen minutes (or until the override is deactivated) regardless of motion or ambient light, and then remains on as long as there is motion, without regard to the presence of light, or remains off, without regard to external conditions (process block 115), respectively.

If neither override is active, logic process 110, proceeds to ask if there is motion (decision box 116). If there is no motion, the light 10 remains dormant. If there is motion, an inquiry is made as to whether there is ambient light above a threshold (decision box 118). If there is, the light 10 remains off and waits for N seconds (process block 120) and tests for motion and light again. In one preferred embodiment N equals 23. If it is dark, light 10 is activated, and after waiting N seconds, the tests for motion and light are performed again (process block 122).

The current consumption of the modes described above are as follows:

1. Still or switched “off” override—light detectors not checked, less than 20 micro amps of current drawn.

2. Motion with light present—light detectors are checked, but for a preferred embodiment that has runs the photo sensors at a duty cycle of less than 0.01 under these conditions, less than 20 micro amps average current is drawn

3. Motion and darkness or switched to “intelligent” override—unit illuminated—less than 125 milliamps.

Skilled persons will recognize that these values permit casual use, for example by a child having a safety, presence-indicating light attached to his bicycle, to use the light without ever having to activate an on/off switch, thereby eliminating the danger of forgetting to switch on the light prior to beginning a journey.

In some preferred embodiments special care is taken to avoid the situation in which the light 10 is attached to a bicycle and use is begun in a lighted garage, thereby keeping the light 10 off, but then the bicycle is taken outside into the darkness. To avoid imposing an overly long waiting period on the user once the light 10 is taken into darkness, an increased frequency of checks for darkness is performed for the first few minutes after motion is detected, once every five seconds or ten seconds, for example.

Also, in some preferred embodiments, extra care is taken to avoid activating the system due to, for example, an accidental bump against a bicycle bearing light 10, while it is in casual garage storage. In one preferred embodiment, the presence of motion is tested five seconds after a first motion detection. If no motion is detected on the second test, there is no subsequent test for darkness and the system is not activated.

### 3.0 Operation Referenced to Schematic

### 3.1 Choosing a State

Referring to FIG. 3, switch SW1 may be used to switch light unit 10 into an “intelligent override” mode or an “unconditional off” mode. In a preferred embodiment the “intelligent override” mode is achieved by briefly depressing switch SW1, thereby briefly grounding pin P6 of a processor U1. The “unconditional off” mode is achieved by depressing switch SW1 (thereby grounding processor U1 pin P6) for at least 2.6 seconds. If neither one of the above described states have been chosen, the unit 10 is in an “active state,” where it constantly monitors for simultaneous motion and darkness.

### 3.2 Energy Efficient Monitoring for the Simultaneous Occurrence of Motion and Darkness

3.2.1 Motion Detection

While unit 10 is in active state, there is a constant monitoring for the presence of motion, as it uses much less energy to monitor for motion, than for darkness. As long as there is no motion, motion detection switch MS1 is in a constant closed (shorted) or open state, causing a constant voltage at processor U1, pin P9. Under this condition processor U1 remains in a sleep mode in which it uses less than 1 μA of current, and the whole unit 10 uses 2.4-2.9 μA. Also, transistor Q1 is kept off, thereby preventing current flow through photo sensors PS. When the light assembly 10 is moved along any axis, motion detection switch MS1 undergoes a closed-to-open transition (in some instances after first closing), causing a low-to-high voltage transition on pin P9 of processor U1. Processor U1 is designed such that such a transition on pin P9 wakes up processor U1, causing it to process a vector that results in pin P7 turning on transistor Q1, resulting in a test of the amount of light hitting photo sensors PS. Op-amps U2 amplify the output of the photo sensors PS and feed this information into a set of identical A to D input pins P10 of processor U1, for a decision. If the input from the photo sensors PS indicates that it is dark, then transistor Q2 is toggled by output pin P9 of the processor U1, to produce a flashing signal from the LEDs LD2.

3.2.2 Darkness Detection

Photo sensors PS have a resistance that is inversely proportional to the level of ambient light. Photo sensors PS have a dark resistance in the multi-mega ohm range, a full sunlight resistance in the range of 10 to 300 of ohms, and a dusk or dawn resistance in the range of 20 KΩ. Therefore, in order to achieve the best resolution of photo sensor input voltage relative to light, for the ON or OFF decision during critical twilight conditions, the resistance level of each of a set of resistors R1, that feed photo sensors PS are set to 20 KΩ. In light conditions approximating those to be found at dawn or dusk, an acceptably accurate reading from photo sensors PS is available within about 50 milliseconds.

The output impedance of the photo sensors PS will vary with light level, therefore buffer op-amps U2 have been inserted into the circuit to present a steady impedance output to the A to D input pins P10 of processor U1. These op-amps are grounded through FET Q1. When FET Q1 is OFF, the op-amps U2 are disconnected from ground and will draw no current.

The photo sensors PS are positioned orthogonally to one another, on the sides of the case 312 (FIG. 2) of unit 10, so that readings are generally taken of the sky and two sides of the cyclist's bicycle. In an alternative preferred embodiment, only the two side-looking photo sensors PS are present. In either embodiment each photo sensor PS has a largely independent view of the ambient light. In one preferred embodiment, one or more of the photo sensors PS are recessed into the case. In an alternative preferred embodiment a photo sensor PS is oriented to face rearward, to serve as a car headlight detector. In this embodiment, when headlights are detected the flash rate is increased.

In one preferred embodiment the photo sensor PS outputs are averaged to find a parameter that is compared to a threshold. In other preferred embodiments the photo sensor registering the lowest light value is used, the two lowest light values are used, or each is compared to a threshold and then the binary “light” and “dark” results are used in a majority rule voting scheme. The scope of this invention encompasses other decision schemes as well.

3.3 Preventing Variation in Battery Voltage from Causing Variation in Apparent Light Intensity

3.3.1 LED Pulse Control Overview

During light 10 active operation, the LEDs LD2 flash at roughly 1.5 times per second. During each flash period LEDs LD2 are toggled on and off, according to a pulse width modulation (PWM) scheme, at a duty cycle that is inversely related to the battery voltage. Low battery voltage is compensated for with a higher duty cycle, so that the flashes do not dim over time, as the batteries are drained.

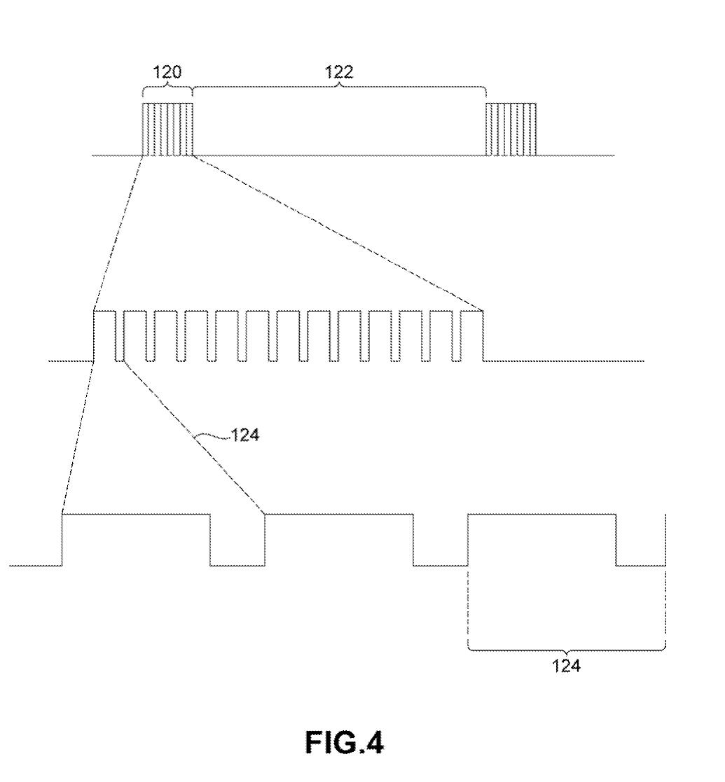

In greater detail, the structure of a light pulse is shown in FIG. 4. In a preferred embodiment a light flash period 120, equals 0.1 seconds, and is followed by a dark period 122, that equals 0.6 Seconds. Accordingly, the flash rate is:

$$F = \frac{1}{Period}$$

$$F = \frac{1}{( 0.1 + 0.6 )}$$

$$F = 1.428 Hz$$

In one preferred embodiment the system clock frequency is 32,768 Hz, and the brightness modulation pulse cycle period 124 is equal to 100 hex (256) clock cycles, to yield 7.812 mSec. In the example shown, the brightness modulation duty factor has been set to 75%, or a count of ‘00C0’ Hex. This equates to a HIGH period of 5.859 mSec and a LOW period of 1.953 mSec. In one preferred embodiment, experimentally determined tables stored in processor U1, or associated memory, translate measurement of battery voltage to the brightness modulation duty factor.

3.3.2 Battery Voltage Measurement

In order to determine the operate duty cycle, the battery voltage must be monitored when LEDs LD2 are flashing. The battery voltage is measured at an A/D input pin P2 of processor U1. To read the battery voltage, a first field effect transistor (FET) Q1 is turned ON by pin P7 of processor U1, thereby allowing current to flow through the voltage divider formed by R5 and R6 (of equal value of about 100 kΩ). This voltage divider will yield a voltage of 0.5 V_{bat}.

Turning the FET Q1 ON will also allow op-amps U2 and U4 to operate correctly, thereby drawing approximately 4 μA of current. Due to this low current level however, the op-amp U4 is quite slow, with a frequency limit of 5 KHz. The circuit is therefore allowed to settle for at least 40 to 50 milliseconds before the processor U1 attempts to read the output voltage on pin P2 or processor U1.

To most accurately gage the state of the battery, readings are taken during active LED LD2 drive, when battery voltage is lowered by producing the drive LED LD2 drive current. Pin P2 is compared to an internal voltage reference of the processor.

Finally it should be noted that, in the embodiment shown in FIG. 3, the combination of the capacitor C1 and resistor R10 (510Ω) forms a low pass filter with respect to the battery voltage. The time constant of this low pass filter is 51 milliseconds. To avoid this lengthy time constant, in an alternative preferred embodiment, R5 is placed in parallel with R10, greatly reducing the time constant. In a preferred method for gauging the state of the battery an LED pulse is initiated and a battery voltage measurement is made at the end of the pulse. The drain on the battery is reflected in the voltage at the voltage divider midpoint.

### 3.4 LED Drive Circuit

The gate of a second FET Q2 is driven by output pin P8 of the processor U1. A HIGH output on pin P6 turns FET Q2 ON while a LOW on this pin turns the FET Q2 OFF. When it is on, FET Q2 will provide a current path to ground for the LED resistor combination. The LED forward voltage can vary from 2.0 to 2.6 volts from unit to unit.

The series resistors, R14, R15, and R17 set the high current limit when Q2 is switched ON. Although the LEDs are rated for up to an absolute current value of 100 mA, the resistors both serve to restrict the current level and also to equalize the current going through each LED. In one preferred embodiment, further circuitry is added to more completely stabilize and equalize the current passing through all of the LEDs.

The value of 24 ohms for R14 limits the current flowing through the LED, when a new set of batteries is installed, to a value between 41.66 mA and 16.66 mA. Since the forward voltage is not known when the unit is assembled, R24 limits the current to a value that is safe in the worst case.

$$I = \frac{( Vbat - Vled )}{R 14 + Rfet}$$

$$I = \frac{( 3.0 - 2.0 )}{27} or I = \frac{( 3.0 - 2.6 )}{27}$$

$$I = 37.04 mA or I = 14.81 mA$$

The total current drawn by the entire unit will be governed almost entirely by the LED current. Therefore the current drawn by the unit when operating will vary from a high of:

I total=3×37.03 ma=111.09 mA

Due to the action of the pulse width modulation circuit, however, the actual current drawn at any given time will be dependent upon the ON-OFF ratio being applied to the LEDs with the PWM circuitry and also upon the ON-OFF flashing rate.

Both of these values of current produce ample light for the purposes of the safety light 10. Referring to FIG. 2, the batteries are connected directly to both the 510Ω input current limiting resistor R10 and to the LEDs LD2 and LD4. Resistor R10 limits the current that is supplied to the rest of the electronics, but since the total current draw will always be less than 4 milliamps, the presence of resistor R10 has no effect unless there is a reversed battery condition, in which case R10 permits current to flow harmlessly in a loop that also includes D1. During normal operation diode D1 is reverse biased and draws no current.

LED LD4 is in series with 33Ω resistor R9 and is also reverse biased so that it will draw no current, unless the batteries are reversed, in which case it lights up to inform the user of the error.

Normal operating current for the unit will vary depending on the operating state. If the LEDs are actively being driven, then the current will range up to as much as;

### 3.5 Energy Consumption and Battery Life

In a preferred embodiment, light unit 10 has components exhibiting the current draws shown in Table 1, below. The current draw of other circuit elements is negligible.

TABLE 1
Current Consumption of Various Functional Circuits

| | Conditions | | |
|---|---|---|---|
| | Active Current | | Quiescent Current |
| Components | Consump. | | Consump. |
| Photocell Circuits | | | |
| Bright Daylight | 453 | μA | 0.06 μA (maximum |
| | | | leakage through Q1 |
| | | | in the “off” state |
| Dusk or Dawn | 228 | μA | 0.06 μA (maximum |
| | | | leakage through Q1 |
| | | | in the “off” state |
| Full Darkness | 12 | μA | 0.06 μA (maximum |
| | | | leakage through Q1 |
| | | | in the “off” state |
| LEDs LD2 | 111.09 | Ma | 1 μA |
| Processor U1 with MCLK | 17 | μA | |
| 32,764 | | | |
| Processor U1 while A/D | 1.8 | mA | |
| Active | | | |

3.5.1 Battery Life For Not Flashing Operation

Referring to Table 1, light 10 current drain when the unit is active but not flashing is approximately:
17 μA

Estimated shelf life of the batteries when the unit is in the low power mode with no motion detected and no processor U1 activity will be approximately;

$$T = \frac{2870 mA Hrs}{0.017 mA}$$

$$T \approx 169 Thousand Hours \approx 19 Years$$

3.5.2 Active Flashing Battery Life

As noted above, maximum current drain when flashing actively (during pulse width modulation “on” times) will be approximately:
111.09 mA

As can be seen from Table 1, the processor U1 current is completely dominated by the drain during an A to D conversion. Similarly, the current consumption of the light unit 10 is dominated by the current drain during active LED flashing.

The battery life to be expected during active flashing is dependent upon and dominated by the flash rate and the PWM duty cycle used during the flash. The 111 mA total current draw cited above assumes that the full battery voltage is present and also that the LEDs have the minimum forward conduction voltage drop, conditions which will yield the absolute maximum current drain of 111 mA for the three LEDs when ON. Because the voltage will drop as the batteries are used up, the maximum current will not remain at 111 mA, even assuming the “worst” case of battery voltage and LED Vf drop.

Device 10 runs on AA Alkaline Batteries, which provide 3.0 V output and have a lifetime rating of from 2400 to 2870 mA Hours, dependent upon both the rate of discharge and the temperature. The “discharged” battery endpoint voltage is typically listed as either 0.8 or 0.9V. At this voltage, the two batteries in series would just be able to drive the processor U1, but supplying the LEDs LD2 is problematic.

If the worst case LED current figures are used, and the flash rate and PWM duty cycle are set to 1.28 Hz, with a 156.25 mSec Flash time and an average PWM duty cycle of 57.45%, then the expected life of the batteries will be:

$$Tlife = \frac{Battery MilliAmp Hours}{Effective LED MilliAmps used}$$

$$111.09 mA * \frac{1.28 Flash}{Second} * \frac{0.15635 Second}{Flash} * 0.5745 = 12.76 mA$$

Assuming a battery capacity of 2870 mA Hours for an AA Alkaline Cell:

$$Tlife = \frac{2870 mA Hrs}{12.76 mA}$$

$$Tlife = 224.9 Hrs .$$

The worst-case estimate of the active flashing time as, for a battery set with a 2870 mA Hrs rating, as shown above is 224.9 hours, for a battery set with a 2400 mA Hrs rating it would be about 188 hours. Accordingly if a user were to use the light in darkness for 1 hour per day, the unit would last for about 224 days (or 188 days, with the 2400 mA Hrs rated battery set) before new batteries would be required. This appears to be a great improvement over the prior art, and one which translates into added safety for the user. Each time it is necessary for batteries to be replaced is a time when the user is potentially left vulnerable, either because the batteries reach their limit during use, or because a user, perhaps overburdened with life's many demands, fails to replace the batteries in a timely manner.

### Components

Push button switch SW1 is available from C&K Components, which has a website at www.ck-components.com, under C&K Part Number ‘PTS645SL70 LFS’. In a preferred embodiment processor U1 is a Texas Instruments model MSP430F2012TPWR. This is a very low power 14-pin processor in a TSSOP surface mount plastic case. It is equipped with 2K of Flash memory, 256 bytes of Flash Data memory, and 128 bytes of RAM. It also has a 10-bit A to D converter with 8 multiplexed inputs. It is capable of entering either one of two sleep mode, LPM3 or LPM4 (which uses even less current), in which, for either sleep mode, it uses less than 1 μA of quiescent current.

In a preferred embodiment photo sensors PS are available from Advanced Photonix, Inc., which has a website at www.advancedphotonix.com, under part number “PDV-P9006”. The motion sensor MS1 is available from Signal Quest, which maintains a website at www.signalquest.com, under part number SQ-SEN-200-IBB. This is a MEMS technology unit, essentially a switch which will change states upon movement. It can settle in either the Open or Closed states when motionless, but it will continuously switch states whenever it is subjected to movement. The minimum current level needed to operate the device is 1 μA.

The light unit 10 is designed to operate using two AA alkaline batteries. Nominal voltage will be in the 3.1 V range but operation will continue until the voltage level drops to approximately 1.8 volts. At the 1.8 V level, the processor U1 operation cannot be guaranteed.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of providing a safety warning light for a traveler over a period of months of intermittent travel, comprising:
(a) providing a battery operated lighting apparatus that provides light when motion and darkness are detected and that when still or in daylight uses, on average, less than 4 milliamps of power; and
(b) over said period of months, using said lighting apparatus when traveling without activating any switch prior to use or deactivating any switch after use.

2. The method of claim 1, wherein said safety warning light is left attached to a personal transportation device during said period of months.

3. The method of claim 2, wherein said personal transportation device is a bicycle.

4. The method of claim 2, wherein said personal safety device is a scooter.

5. The method of claim 1, wherein said safety warning device is left attached to an article of outer clothing.

6. A battery operated lighting apparatus that provides light when motion and darkness are detected and that when still or in ambient light uses less than 4 milliamps of current.

7. The apparatus of claim 6, which uses less than 1 milliamp of current.

8. The apparatus of claim 6, wherein said current is from a DC voltage source of less than 6 volts.

9. A battery operated lighting apparatus that includes a battery, producing a battery voltage, and a light producing assembly that is, at times, driven by electrical pulses having a duty factor, and wherein said duty factor is varied in inverse proportion to battery voltage, so that as said battery voltage decreases over battery life, said duty factor is increased so as to maintain a substantially constant illumination level.

10. The battery operated lighting apparatus of claim 9, wherein said light producing assembly includes at least one light emitting diode.

11. The battery operated lighting apparatus of claim 9, wherein said pulses having a duty factor are grouped together into larger pulses, so that said lighting assembly blinks on and off, when activated.

12. A battery operated lighting apparatus that is activated, at least in part, in response to darkness, and wherein said lighting apparatus includes at least two light sensors placed to detect light levels in differing directions from said lighting apparatus, and wherein readings from at least two of said light sensors are used in a determination of a darkness condition.

13. The battery operated lighting apparatus of claim 12, wherein said readings from said light sensors are averaged and thresholded to determine a darkness condition.

14. A battery operated lighting apparatus that is activated by presence of darkness and motion and including a hard-off user input that when activated places said lighting apparatus in a hard off state in which said apparatus will remain deactivated without regard to the presence of motion and darkness.

15. A battery operated lighting apparatus that is activated by presence of darkness and motion and in which motion must occur twice, at least one time-duration apart, for said device to be activated, in order to prevent accidental activations due to temporary motion.

16. The battery operated lighting apparatus of claim 15, wherein said time duration is about ten seconds.

17. A battery operated lighting device that detects a low battery condition and emits a signal to alert a user of said condition.

18. The battery operated device of claim 17, wherein said signal is a rapid flashing of said lighting device.

19. The battery operated device of claim 17, wherein said device further includes a speaker and wherein said signal is an auditory signal produced by said speaker.

20. A battery operated lighting apparatus that is activated by the presence of motion and darkness, and wherein when motion at a rate greater than once per every fifteen seconds, the rate of checking for darkness is maintained a rate of less than once per fifteen seconds, in order to preserve battery power.

21. The battery operated lighting apparatus of claim 20, wherein after motion has been detected for greater than a predetermined period of time, the rate of checking for darkness is reduced.
